(19) United States
(12) Patent Application Publication
(10) Pub. No.: US 2026/0213055 A1
(43) Pub. Date: Jul. 23, 2026

(54) A High Temperature Superconducting Coil with a Resistive Impregnated Winding and its Manufacturing Method

(71) Applicant: COMMISSARIAT A L'ENERGIE ATOMIQUE ET AUX ENERGIES ALTERNATIVES, Paris (FR)

(72) Inventors: Thibault LECREVISSE, Gif sur Yvette (FR); Philippe FAZILLEAU, Gif sur Yvette (FR); Françoise RONDEAUX, Gif sur Yvette (FR)

(73) Assignee: COMMISSARIAT A L'ENERGIE ATOMIQUE ET AUX ENERGIES ALTERNATIVES, Paris (FR)

(21) Appl. No.: 19/140,286

(22) PCT Filed: Dec. 22, 2023
(86) PCT No.: PCT/EP2023/087700

§ 371 Date: Jun. 17, 2025

(30) Foreign Application Priority Data
Dec. 22, 2022 (EP) 22307012.9

(51) Int. Cl. H01F 6/06; H01F 6/02; H01F 27/32; H01F 41/04; H01F 41/12

(52) U.S. Cl. CPC H01F 6/06; H01F 6/02; H01F 27/323; H01F 27/327; H01F 41/048; H01F 41/122

(57) ABSTRACT

The invention concerns a high temperature superconducting coil (HTSC) comprising:—a tape (HTS-TP) made of a high temperature superconducting material, said tape being wound up into a plurality of turns;—a resistive layer (RL) arranged between and in contact with said turns; characterized in that said resistive layer (RL) comprises: ⋅ a mesh (MSH) made of a metallic-based material with a first electric resistivity and, an impregnation material (IM) with a second electric resistivity different from the first electric resistivity, said impregnation material filling said mesh, or ⋅ a tape (TP) made of a metallic-based material with a first electric resistivity, said tape being patterned with through openings (TO) and, an impregnation material (IM) with a second electric resistivity different from the first electric resistivity, said impregnation material filling said through openings.

### TECHNICAL FIELD OF THE INVENTION

The present invention relates to the field of superconducting magnets, and more especially to high temperature superconducting magnet.

### PRIOR ART

An important aspect to consider for a superconducting magnet is the irreversible change of state, from the superconducting one to the resistive one, known as “quench”. The superconducting magnets need to be protected against this phenomenon as it can provoke irreversible damages, especially due to thermal heating induced by the propagation of a resistive zone within the superconducting magnet.

It is a well-known problem for all superconducting magnets but which becomes critical when considering High Temperature Superconductors (HTS).

Indeed, during a quench of a HTS magnet, the propagation velocities of the resistive zone (i.e ‘normal’ zone, not superconducting) are very low and the associated resistive voltage grows consequently very slowly. This generally leads to a late voltage detection of the quench and a high risk of thermally induced local damages for the HTS magnet.

Solutions to avoid such a situation have already been proposed, in particular for HTS coils:

A way to protect a HTS coil in case of a local resistive transition is to remove any electrical insulation between turns. It allows the current to automatically bypass the resistive area of the HTS coil, by letting the current pass from a turn to another (radially). It is a proven and efficient protection way against thermal damages. However, a major drawback of such a solution is the large electrical time constants of the radial currents, especially during the charge of the magnet. Another drawback is that the turns are not mechanically linked together (this aspect is also qualified as a “dry winding technology” in the literature). Both drawbacks are inducing a complex mechanical behavior (some turns of the coil might lose their contact, limiting the self-protecting behavior), a heat dissipation and a loss of magnetic field quality when charging or discharging the coil. In addition, a “dry winding technology” is not optimal for the internal cooling of the coil due to the “voids” inside the winding, which are induced by the superconducting cable thickness and width fluctuation.

An alternative solution is based on the “Metal-as-Insulation technology” (MI), which consists of adding a resistive layer, basically made of a metallic tape, between the turns of the HTS coil. The metallic tape adds a resistance due to the material itself but also to the contact surfaces with the coil turns. It allows lowering the current bypass in normal working conditions and in the same time decreasing the associated electrical time constants. This solution therefore reduces drastically the current bypass between turns and then limits the unwanted unbalanced and torque forces between elements inside the coil. The resistance can be set by the choice of metal for the tape and its thickness. The effectiveness of this solution for high magnetic fields has been proven in recent works, see for example in the article of Ph. Fazilleau et al, “38 mm diameter cold bore metal-as-insulation HTS insert reached 32.5T in a background magnetic field generated by resistive magnet”, Cryogenics, Volume 106 (2020) (A1).

In order to more easily set the resistance value of the metallic tape, it has also been proposed specific designs.

For example, in the field of PI technology, WO 2019/150123A1 (A2) proposes a partially-insulating structure made of a metallic tape sandwiched between two insulating layers, each insulating layer comprising windows through which electrical contact can be made with the turns of the HTS coil and said windows being further offset from an insulating layer to the other. The number of windows for each insulating layer as well as the offset in the windows from an insulating layer to another allow setting the resistive value of the partially-insulating layer. In this document, it is also proposed solutions to make sure that the tape is mechanically connected to the HTS coils, for example by means of an adhesive (e.g. epoxy resin) or mechanical means. In that way, the drawbacks of the “dry winding technology” are no longer encountered.

As another example, and more recently, an alternative solution to the MI technology has been proposed. It is based on the use of a resistive layer made of a charged conductive epoxy resin between the turns of the coils. We may refer to Bouloukakis & al., “Discharge Behaviour and Modelling of a 1.5 T REBCO Magnet With Quench Tolerant Coils Impregnated With Conductive Epoxy,” in IEEE Transactions on Applied Superconductivity, vol. 31, no. 5, pp. 1-5, Aug. 2021, Art no. 4601105, doi: 10.1109/TASC.2021.3059975 (A3). This solution brings a resistance between the turns of the coil, as the MI technology does. The resistance value can be set during the manufacturing, by adjusting the different components of the epoxy solution. In addition, and as already mentioned, the epoxy solution (resin) forms once dried an adhesive that allows a mechanical connection with the turns of the HTS coil.

A recent review of the existing techniques is available in the article of T. Lécrevisse et al, Supercond. Sci. Technol., 35(2022 ), 074004 (pp. 18) (A4).

An aim of the invention is to propose another solution

### SUMMARY OF THE INVENTION

To reach that aim, the invention proposes a high temperature superconducting coil comprising:
a tape made of a high temperature superconducting material, said tape being wound up into a plurality of turns;
a resistive layer arranged between and in contact with said turns; characterized in that said resistive layer comprises: a mesh made of a metallic-based material with a first electric resistivity and an impregnation material, either dielectric or conductive but with a second electric resistivity different than the first electric resistivity, said impregnation material filling said mesh, or a tape made of a metallic-based material with a first electric resistivity, said tape being patterned with through openings and an impregnation material either dielectric or conductive but with a second electric resistivity different than the first electric resistivity, said impregnation material filling said through openings.

Other features of the coil according to the invention, taken alone or in combination, are also provided:
said mesh is a fabric, such as a woven fabric or a knitted fabric;
said tape patterned with through openings is made of Zigzag tape;
said metallic-based material for the mesh or for the tape patterned with through openings is chosen amongst: steel, stainless or not, copper or copper alloys, aluminum or aluminum alloys;
said impregnation material is either dielectric chosen amongst a resin, such as an epoxy resin, wax, an oxide paste, or a metallic-based material;
said mesh or said tape patterned with through openings is covered by a coating to adapt a contact resistance between on the one hand, said mesh or said tape patterned with through openings and on the other hand, the tape made of a high temperature superconducting material;
said second electric resistivity of the impregnation material is different than said first electric resistivity of the metallic-based material making the mesh or the tape patterned with through openings.

The invention also proposes a method for manufacturing a high temperature superconducting coil according to the invention, comprising the followings steps:
a) building up a laminate with the following sub-steps:
a₁) providing a tape made of a high temperature superconducting material,
a₂) providing a mesh or a tape patterned with through openings, made of a metallic-based material with a first electric resistivity,
a₃) placing said mesh or said tape patterned with through openings over the tape made of a high temperature superconducting material,
a₄) impregnating said mesh or said tape patterned with through openings with an impregnation material having a second electric resistivity, different from said first electric resistivity of the metallic-based material of the mesh or the tape; said mesh or said tape patterned with through openings, together with the impregnation material being intended to form said resistive layer;
b) winding up the laminate on itself to make turns, and
c) hardening the impregnation material of said laminate.

Other features of the method according to the invention, taken alone or in combination, are also provided:
the sub-steps a₃) and a₄) are made concurrently;
the step b) is made concurrently to the sub-step a₄);
the step b) is made between the sub-step a₃) and the sub-step a₄).

### BRIEF DESCRIPTION OF THE DRAWINGS

Other features and advantages of the invention will appear by reading the detailed description that follows and for which one will rely on the annexed drawings in which:

FIG. 1 is a picture of a high temperature superconducting coil according to the invention;

FIG. 2 is a cut-off view of a high temperature superconducting coil according to the invention between two turns of said coil;

FIG. 3 shows in top view a mesh than can be used in a resistive layer of the coil;

FIG. 4 shows an alternative where the mesh is replaced by a tape with through openings, according to a first embodiment in FIG. 4(a) in perspective view, according to a second embodiment in FIG. 4(b) in perspective view, according to a third embodiment in FIG. 4(c) in top view;

FIG. 5 represents another alternative for which the mesh, shown in cut-off view according to its thickness, is covered by a coating to further adapt the contact resistance with the high temperature superconducting tape;

FIG. 6 is a scheme of the different steps of a possible manufacturing method of a high temperature superconducting coil according to the invention;

FIG. 7 is a scheme of an experimental setup to test the high temperature superconducting coil;

FIG. 8 is a curve obtained with the experiment setup of FIG. 7 showing, for several tests, the evolution of the central magnetic induction in the coil, in mT, as a function of time, in ms, after a discharge of 20 A;

FIG. 9 is a curve obtained with the experimental setup of FIG. 7, showing the evolution of the current, in A, the voltage, in V, and the central magnetic induction, in mT of the coil as a function of time, in seconds, in order to check the stability of the coil with regard to a quench;

FIG. 10 is a curve obtained with the experimental setup of FIG. 7, showing the evolution of current, in A, the voltage, in V, and the central magnetic induction, in mT of the coil, as a function of time, in seconds, in order to check the coil robustness to pulsed quenches.

### DETAILED DESCRIPTION OF THE INVENTION

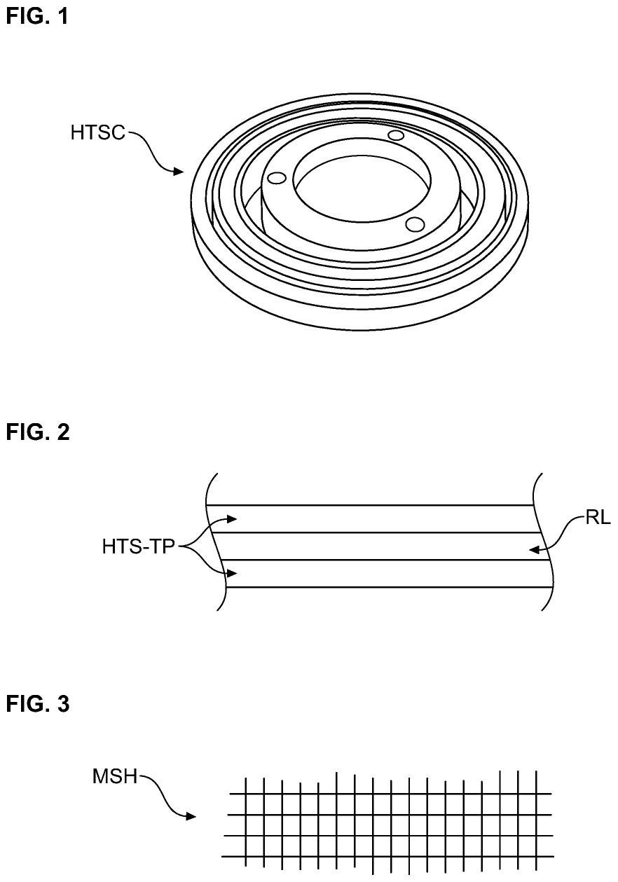

A high temperature superconducting coil HTSC according to the invention is shown in FIG. 1 (general view) and FIG. 2 (cut-off view).

The high temperature superconducting coil HTSC comprises a tape HTS-TP made of a high temperature superconducting material, wound up in several turns and a resistive layer RL arranged between and in contact with said turns. It can be seen in FIG. 2 where the resistive layer is shown between two consecutive turns of the tape HTS-TP.

The resistive layer RL may be made in different ways.

In FIG. 3, the resistive layer RL comprises a mesh MSH made of a metallic-based material with a first electric resistivity and an impregnation material IM with a second electric resistivity different than the first electric resistivity, said impregnation material IM filling said mesh MSH.

The mesh MSH may in particular be a fabric, such as a woven fabric or a knitted fabric. For example, a woven fabric (tissue) of stainless steel may be employed.

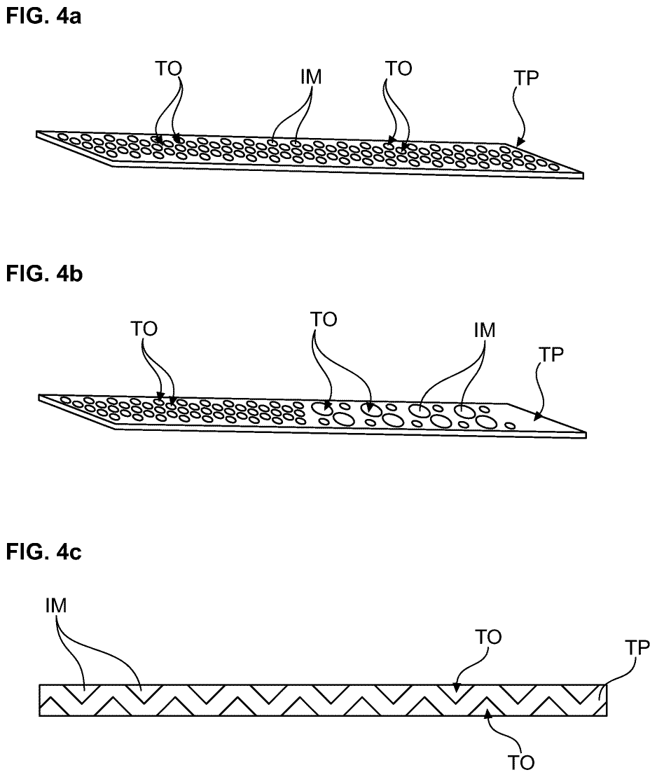

In FIG. 4, the resistive layer RL comprises a tape TP made of a metallic-based material with a first electric resistivity, said tape being patterned with through openings TO and an impregnation material IM with a second electric resistivity different than the first electric resistivity, said impregnation material filling said through openings.

More precisely, FIG. 4(a) shows a tape which through openings are holes all identical (given dimensions), additionally preferably evenly distributed along the tape.

FIG. 4(b) shows a tape which through openings are holes with variable dimensions, and eventually not evenly distributed along the tape.

FIG. 4(c) shows a tape which through openings are obtained by the zigzag shape of the tape.

In any case, the metallic-based material for the mesh MSH or for the tape TP patterned with through openings TO may be chosen amongst: steel, stainless steel, copper and copper alloys (including Copper Beryllium alloys, brass, . . . ), aluminum and aluminum alloys.

In any case also, the impregnation material IM may be either a dielectric chosen amongst: a resin, such as an epoxy resin, wax, an oxide paste, or a metallic-based materiel. In particular a resin is particularly well adapted due to its bonding properties and its high dielectric properties.

The mesh MSH or said tape TP patterned with through openings TO may be covered by a coating CTG. A coating CTG may be useful to adapt the contact resistance between on the one hand, said mesh MSH or said tape TP patterned with through openings TO and on the other hand, the tape HTS-TP made of a high temperature superconducting material.

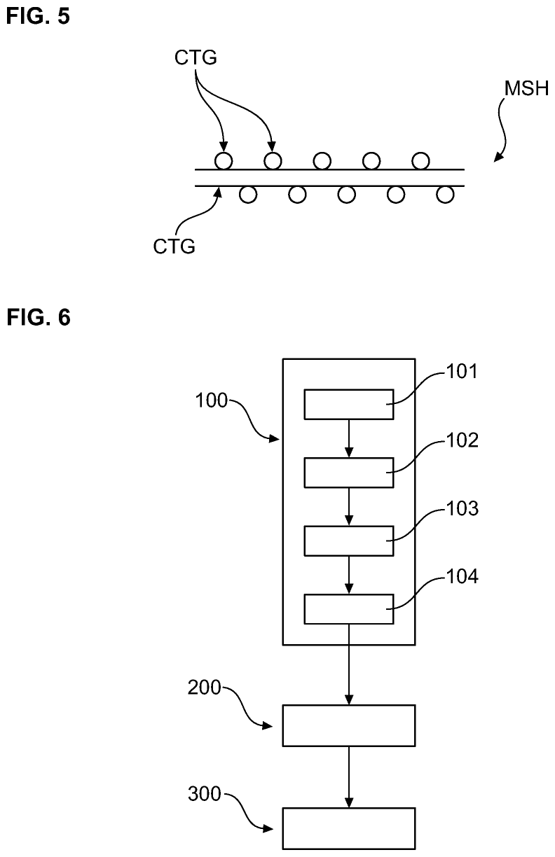

FIG. 5 for example shows where this is deposited in the case of the use of a mesh within the resistive layer.

Of course, the coating may also be deposited on the surfaces of the tape TP with through openings TO intended to be in contact with the high temperature superconductive tape HTS-TP for any of the alternatives represented in FIG. 4(a) to 4(d) (not shown in the drawings).

The coating may deposited by atomic layer deposition (ALD) with a thickness typically comprised between 100 nm and 1 μm. The coating may for instance be made of aluminum oxide or of a mixture of aluminum and zinc oxides.

FIG. 6 shows a possible manufacturing method of a high temperature superconducting coil HTSC according to the invention.

A first step 100 consists in building up a laminate with the following sub-steps:
providing 101 a tape HTS-TP made of a high temperature superconducting material,
providing 102 a mesh MSH or a tape TP patterned with through openings TO, made of a metallic-based material with a first electric resistivity,
placing 103 said mesh MSH or said tape TP patterned with through openings TO over the tape made of a high temperature superconducting material, and
impregnating 104 said mesh MSH or said tape TP patterned with through openings TO with an impregnation material IM with a second electric resistivity different than said first electric resistivity of the metallic-based material of the mesh MSH or the tape TP.

The mesh MSH or said tape TP patterned with through openings TO, together with the impregnation material IM are intended to form the resistive layer RL.

A second step 200 consisting in winding up the laminate on itself to make turns.

A third step 300 consisting in hardening the impregnation material IM of said laminate. The manufacturing method may be made in successive steps, in the order mentioned here above, but it is not necessary.

For example, the sub-steps 103 and 104 may be made concurrently.

As another example, step 200 may be made concurrently with sub-step 104.

As another example, step 200 may be made between sub-step 103 and sub-step 104.

### Proof of Concept

A high temperature superconducting coil was manufactured as mentioned previously.

The high temperature superconducting tape (“HTS tape”) chosen is 6 mm wide and 76 μm thick and a total of 25.5 m is require to wind a pancake coil.

The resistive layer is made of a stainless steel mesh filled by an epoxy resin as impregnation material. The mesh is more precisely a woven fabric (tissue). The tissue considers 30 μm strands which leads to a total thickness of 60 μm. The open area (%) of this mesh, within the epoxy resin can get through, is of 49%. The length and width of the mesh correspond to that of the HTS tape. A room temperature curing epoxy resin with a thermal contraction coefficient similar to that of HTS material has been used for the proof of concept pancake coil.

The rolling up of the superconducting tape together with the mesh and the impregnation are made at the same time.

The pancake coil presents an inner diameter of 60 mm and an outer diameter of 99.1 mm with about 100 turns. The coil inductance is of 1.035 mH and the coil magnetic constant of 1.617 mT/A.

### Experimental Setup and Results

In order to prove the self-protective behavior of the coil detailed in the “Proof of concept”, its behavior has been tested with an experiment setup.

For that, the coil HTSC have been dipped into a liquid nitrogen (LN2) bath BTH at 77 K. The voltage U of the coil has been monitored, as well as the current I (it can be done by adding tow soldered taps at both ends of the coil) and a Hall sensor (Arepoc) has been used to monitor the central magnetic induction of the coil.

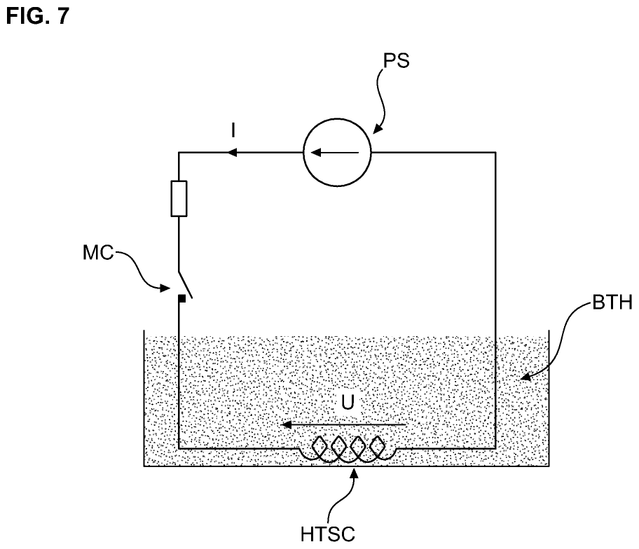

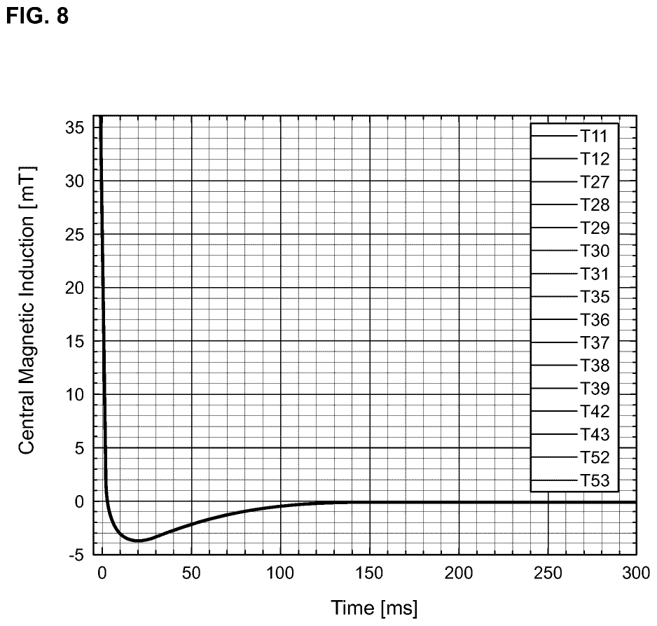

A scheme of the experimental setup is shown in FIG. 7 (Hall sensor not shown).

About 60 tests have been performed with this coil, including three thermal cycles from room temperature to LN₂ bath condition (77 K) and many quench tests.

FIG. 8 shows, for 16 of the 60 tests carried out, the evolution of the central magnetic induction (mT) as a function of time (ms) for a 20 A current sudden discharge.

Firstly, the coil HTSC is charged thanks to a power supply PS with a ramp, up to 20 A, the mechanical contactor MC being closed for that. Then, the mechanical contactor MC is suddenly open. Finally, the magnetic field is monitored as a function of time from the opening of the mechanical contactor MC (t=0 s).

This kind of test allows evaluating the contact resistance between the high temperature superconducting tape and the resistive layer.

We can see that the curve is similar for all the tests presented in FIG. 8, meaning that the contact resistance is constant. We can therefore expect a reproducible behavior of the coil during charging and discharging, even after thermal cycles and quenches. It also indirectly shows that the contact between the high temperature superconducting tape and the resistive layer (mesh+epoxy resin) is maintained. Indeed, thanks to the epoxy resin, the resistive layer is bonded between two turns of the high temperature superconducting tape.

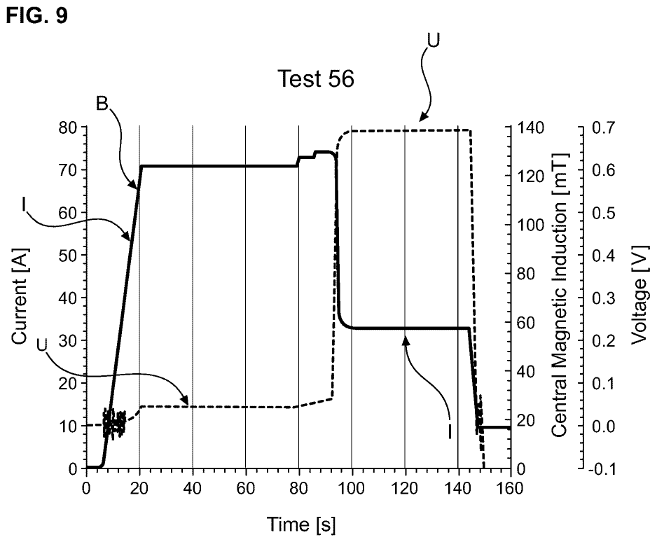

FIG. 9 shows the evolution of the current I (A), the voltage U (V) and the central magnetic induction B (mT) of the coil as a function of time(s) in a first test situation.

Firstly, the coil is charged at 2 A below the quench current (ramp up in the range 0-20 s; current of 70 A). Then, the power supply voltage is kept constant at a low value to passively protect the coil, during about 60 s (range 20-78 s)—intensity is kept constant at 70 A in the same range of time. Thereafter, the current is increased by steps of 1 A up to the quench (range 88-92 s; quench at 72 A). A discharge can then be observed at t=92 s, the current diminishing drastically and suddenly to a value of 32 A, showing a self-protection of the coil against the quench. Concurrently to the dawn of current, the voltage raises, up to 0.7 V (limit value imposed by the power supply). At t=145 s, the current is progressively cut with a ramp down. It has to be noted that the evolution of the central magnetic induction with the evolution of the current are similar and, due to the scales chosen in FIG. 9, overlaid. That is why we can actually distinguish only two curves in FIG. 9.

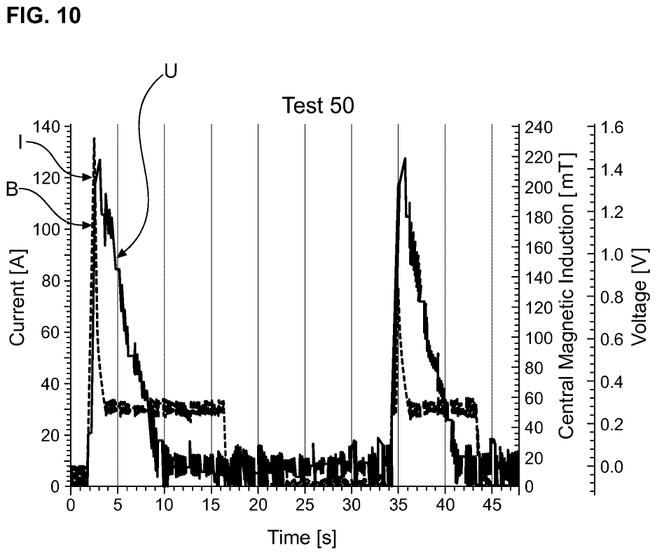

FIG. 10 shows the evolution of the current I (A), the voltage U (V) and the central magnetic induction (mT) of the coil as a function of time(s) in another test situation.

Firstly, the coil is charged with a ramp rate value of 200 A/s up to 134 A (pulse current test). This current value corresponds to about 1.86 time the quench current (the quench current is of 72 A as mentioned previously). A discharge can then be quickly observed, the current diminishing drastically and suddenly to a value of 32 A, showing a self-protection of the coil against the quench. In the same time, the voltage also diminishes as the current pulse does not allow heating a sufficient volume of the coil to keep the coil in a modified state (contrary to the test shown in FIG. 9). At t=17 s, the coil, frozen by the cryogenic bath, becomes again superconducting. Finally, at t=34 s, a new pulse of current is sent: the behavior is the same. It has to be noted that the evolution of the central magnetic induction with the evolution of the current are similar and, due to the scales chosen in FIG. 10, even overlaid. That is why we can actually distinguish only two curves in FIG. 10.

1. A high temperature superconducting coil (HTSC) comprising:
a tape (HTS-TP) made of a high temperature superconducting material, said tape being wound up into a plurality of turns;
a resistive layer (RL) arranged between and in contact with said turns; characterized in that said resistive layer (RL) comprises:
a mesh (MSH) made of a metallic-based material with a first electric resistivity and an impregnation material (IM), either dielectric or conductive but with a second electric resistivity different than the first electric resistivity, said impregnation material filling said mesh, or
a tape (TP) made of a metallic-based material with a first electric resistivity, said tape being patterned with through openings (TO) and an impregnation material (IM) either dielectric or conductive but with a second electric resistivity different than the first electric resistivity, said impregnation material filling said through openings.

2. A high temperature superconducting coil (HTSC) according to claim 1, wherein said mesh (MSH) is a fabric, such as a woven fabric or a knitted fabric.

3. A high temperature superconducting coil (HTSC) according to claim 1, wherein said tape (TP) patterned with through openings (TO) is made of Zigzag tape.

4. A high temperature superconducting coil (HTSC) according to claim 1, wherein said metallic-based material for the mesh (MSH) or for the tape (TP) patterned with through openings (TO) is chosen amongst: steel, stainless steel, copper or copper alloys, aluminum or aluminum alloys.

5. A high temperature superconducting coil (HTSC) according to claim 1, wherein said impregnation material (IM) is either dielectric chosen amongst a resin, such as an epoxy resin, wax, an oxide paste, or a metallic-based material.

6. A high temperature superconducting coil (HTSC) according to claim 1, wherein said mesh (MSH) or said tape (TP) patterned with through openings (TO) is covered by a coating (CTG) to adapt a contact resistance between on the one hand, said mesh (MSH) or said tape (TP) patterned with through openings (TO) and on the other hand, the tape (HTS-TP) made of a high temperature superconducting material.

7. (canceled)

8. A method for manufacturing a high temperature superconducting coil (HTSC) according to claim 1, comprising the followings steps:
a) building up a laminate with the following sub-steps:
a₁) providing a tape (HTS-TP) made of a high temperature superconducting material,
a₂) providing a mesh (MSH) or a tape (TP) patterned with through openings (TO), made of a metallic-based material with a first electric resistivity,
a₃) placing said mesh (MSH) or said tape (TP) patterned with through openings (TO) over the tape made of a high temperature superconducting material,
a₄) impregnating said mesh (MSH) or said tape (TP) patterned with through openings (TO) with an impregnation material (IM) having a second electric resistivity, different from said first electric resistivity of the metallic-based material of the mesh (MSH) or the tape (TP);
said mesh (MSH) or said tape (TP) patterned with through openings (TO), together with the impregnation material (IM) being intended to form said resistive layer (RL);
b) winding up the laminate on itself to make turns, and
c) hardening the impregnation material (IM) of said laminate.

9. A method according to claim 1, wherein the sub-steps a₃) and a₄) are made concurrently.

10. A method according to claim 8, wherein the step b) is made concurrently to the sub-step a₄).

11. A method according to claim 8, wherein the step b) is made between the sub-step a₃) and sub-step a₄).
